(19) United States
(12) Patent Application Publication
(10) Pub. No.: US 2007/0215189 A1
(43) Pub. Date: Sep. 20, 2007

(54) Cleaning apparatus

(76) Inventor: Salvatore J. Ruggiero, Cornwall, NY (US)

Correspondence Address: JOHN MAIER, III, 660 AARON COURT, KINGSTON, NY, 12401, US

(21) Appl. No.: 11/378,783

(22) Filed: Mar. 18, 2006

(51) Int. Cl. B08B 3/00

(52) U.S. Cl. 134/103.2; 134/131; 134/151; 134/199

(57) ABSTRACT

An apparatus is provided for cleaning products such as squid and having a support frame with a start end and a finish end. The frame also has a top member and a base and includes start posts that are vertically oriented at the start end and finish posts at the finish end that are vertically oriented Top supports are further included in the frame. The top supports are horizontally oriented and are connected to the start posts and the finish posts. Lower horizontal supports being connected to the start posts and the finish posts. An upper conveyor has a start end with start wheels mounted on the start posts toward the top support and upper finish wheels mounted on the finish posts toward the top support. An upper convey is formed from an open wire mesh mounted to move on the upper start wheels and the upper finish wheels. The upper conveyor belt has an upper outside section and an upper inside section. A lower conveyor has a pair of lower start wheels and a pair of lower finish wheels. The lower start wheels are mounted on the start posts toward the base and the finish wheels are mounted on the finish posts toward the base. A lower conveyer belt is formed from open wire mesh mounted to move on the lower start wheels and the lower finish wheels. The lower conveyor belt has a lower outside section and a lower inside section. The inside section of the upper conveyor and the inside section of the lower conveyor are adapted to move together in a spaced relationship. A wash tank is mounted between the lower vertical section and the lower inside section including air, nozzles to inject air into the wash tank. A plurality of lower nozzles are directed upwardly toward the inside section of the lower conveyor belt. A plurality of upper nozzles directed downwardly toward the upper inside section of the upper conveyor. An upper gear affixed to the upper finish wheel and a lower gear is affixed to the lower finish wheel, the upper gear and the lower gear being the same size; and a motor and intermediate gear are used to rotate the upper gear and the lower gear to move the inside section of the upper conveyor and the inside section of the lower conveyor at the same rate of speed and in the same direction.

### RELATED APPLICATIONS

This application claims priority based upon Provisional Patent application Ser. No. 60/633,177 filed on Mar. 18, 2005.

### BACKGROUND OF THE INVENTION

1. Field of the Invention

This invention relates to cleaning apparatus for cleaning products and, most specifically, relates to a cleaning apparatus for cleaning fish, such as squid, to remove skin and any other undesirable surface material.

2. Prior Art

In the preparation of food, it is frequently necessary that it be cleaned an that undesirable matter be removed from its surface. One product where this is important is fish and it is most certainly true of squid. When squid is processed, it is first necessary to cut off the tentacles of the squid. The squid is then placed in an agitated bath to loosen the skin and to permit the skin to be more easily removed. In the past, this removal has been manually performed. Unfortunately, as can be readily seen, the use of manual labor is expensive and time consuming.

3. Objects

The objects of this invention are to provide a cleaning device as follows:

1. That can. automatically and continuously remove undesired surface material from a product.

2. That can be used for cleaning squid with limited manual labor after removal of the tentacles.

3. That is economical to produce.

4. That is efficient and durable.

### SUMMARY OF THE INVENTION

An apparatus for cleaning products which has a support frame. An upper conveyor is mounted on the frame and has as upper outside section and a upper inside section. Also, a lower conveyor is mounted on the frame and has a lower outside section and a lower inside section. The lower inside section of the lower conveyor and the upper inside section of the upper conveyor move together in a closely spaced relationship. A plurality of nozzles are directed toward the upper inside section. Means are further provided for moving the upper inside section and the lower inside section and th lower inside section in the same direction at substantially the same rate of speed.

### BRIEF DESCRIPTION OF THE DRAWINGS

FIG. 1 is a side elevation of the cleaning device.

FIG. 2 is a plan view of a portion of the conveyor belt used in th cleaning process showing squid as the product on the conveyor belt.

FIG. 3 is a top plan view of the cleaning device.

FIG. 4 is a cross-sectional view along lines 44 of FIG. 1.

### BRIEF DESCRIPTION OF THE NUMERALS

| NUMERAL | DESCRIPTION |
|---|---|
| 11 | Frame |
| 13 | Vertical Posts |
| 15 | Start End |
| 17 | Finish End |
| 19 | Upper Horizontal Supports |
| 21 | Base |
| 22 | Lower Horizontal Support |
| 23 | Upper Conveyor |
| 25 | Upper Start Wheels |
| 27 | Start Posts |
| 29 | Upper Finish Wheels |
| 31 | Finish Posts |
| 33 | Upper Conveyor Belt |
| 35 | Lower conveyor |
| 36 | Lower Conveyor Belt |
| 37 | Lower Start Wheels |
| 39 | Lower Finish Wheels |
| 41 | Intermediate Support Posts |
| 42 | Nozzles |
| 43 | Upper Outside Section |
| 45 | Upper Inside Section |
| 47 | Lower Inside Section |
| 49 | Lower Outside Section |
| 51 | Upper Initial Nozzles |
| 53 | Upper Secondary Nozzles |
| 55 | Lower Initial Nozzles |
| 57 | Lower Secondary Nozzles |
| 59 | Initial Cleaning Tank |
| 61 | Product |
| 63 | Idler Wheels |
| 65 | Air Nozzles |
| 67 | Secondary Cleaning Tank |
| 71 | Drive Wheels |
| 73 | Gears |
| 75 | Motor |
| 77 | Motor Gear |
| 79 | Transfer Gears |

### DETAILED DESCRIPTION OF THE PREFERRED EMBODIMENT

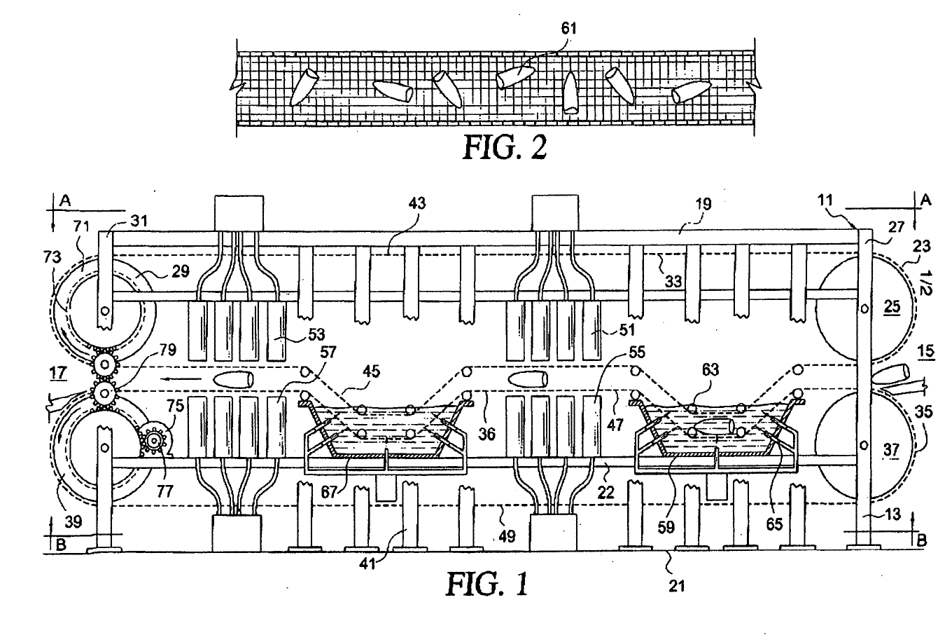

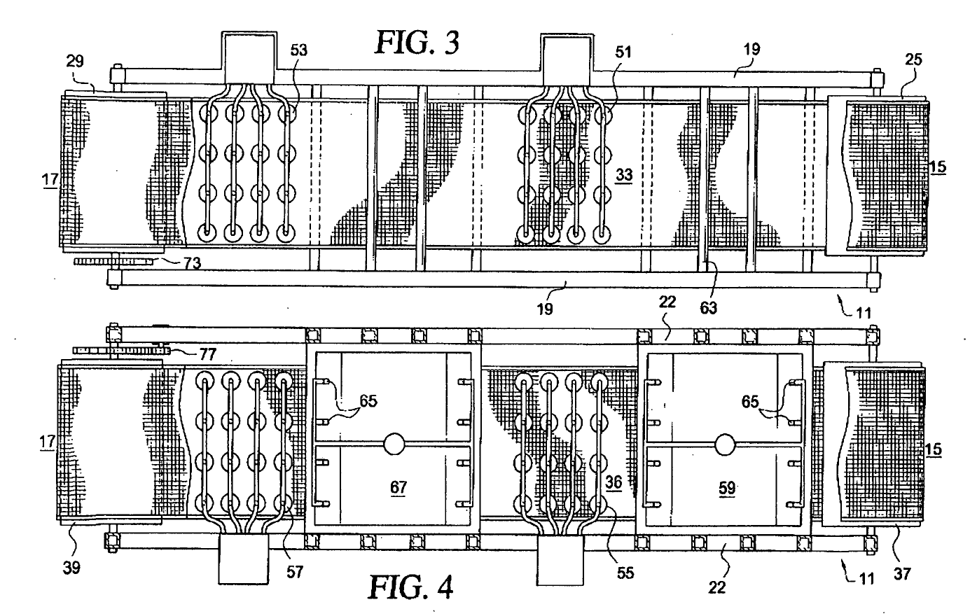

Referring now to FIG. 1, the cleaning device can be seen from a side view. A frame 11 is provided having vertical posts 13 at both ends, namely at a start end 15 and at a finish end 17. An upper horizontal support 19 extends across the top of the vertical posts 13. The cleaning device is mounted upon a base 21. Mounted over the base 21 is a lower horizontal support 22 which is substantially parallel to the upper horizontal supports 19 but substantially lower than the upper horizontal supports 19. The lower horizontal supports 22 are also supported by the start posts 37 and the finish posts 31. At the start end 15, an upper conveyor 33 includes upper start wheels 25 which are mounted to rotate at the start posts 27 and at the opposite end in the finish posts 31. An upper conveyor belt is wrapped around both the upper start wheels 25 and the upper finish wheels 29. Below the upper conveyor 23 is a lower conveyor 35. The lower conveyor belt 36 is mounted upon lower start wheels 37 and lower finish wheels 39. Intermediate support posts 41 extend upwardly as shown in broken away in FIG. 1. The intermediate support posts 41 add further support to the upper horizontal supports 19.

The upper conveyor belt has an upper inside section 43 which faces away from the lower conveyor belt 35 and an upper inside section 45 h faces toward the lower conveyor belt 35. The lower conveyor belt 35 has a lower inside section 47 and a lower outside section 49. The lower outside section 49 faces the base 21 while the lower inside section 47 faces the upper conveyor belt 33. Air may be blasted downwardly toward the upper inside section 45 of the upper conveyor 23 and is also blasted upwardly toward the lower inside section 47 by a plurality of nozzles 42.

Mounted on the op horizontal supports 19 within the upper conveyor 23 are both initial upper inside nozzles 51 and also upper secondary nozzles 45. Both the upper initial nozzles 51 and the upper secondary nozzles 53 are directed toward the upper inside section 45 of the upper conveyor belt 33. Mounted on the lower horizontal supports 22 within the lower conveyor 35 are both lower initial nozzles 55 and also lower secondary nozzles 57. Both the lower vertical nozzles 55 and the lower secondary nozzles 57 are directed upwardly toward the lower inside section 47 of the lower conveyor 35. The nozzles 42 may be used either as vacuums or as blowers. When either the upper initial nozzles 51 or the upper secondary nozzles 53 are used as blowers, they blast air downwardly toward the lower conveyor 35. When used as a vacuum, the upper initial nozzles 51 and the upper secondary nozzles 53 draw air away from the lower conveyor 35. Similarly, the lower initial nozzles 55 and the lower secondary nozzles 57 blow air upwardly toward the upper conveyor 23 and draw air form the upper conveyor 23 when used as a vacuum. It is essential that nozzles 42 which oppose one another not both be used as either blowers or as vacuums but rather that one be used as a blower and the other be used as a vacuum.

When the upper initial nozzles 51 are used as a vacuum, the lower initial nozzles should be used as blowers and vice versa. Similarly, when the lower secondary nozzles 57 are used as a vacuum, the upper secondary nozzles 53 would be used as blowers. Also, is the upper initial nozzles 51 are used as blowers, the upper secondary nozzles 53 should be used as vacuums and vice versa. Similarly, if the lower secondary nozzles 55 are used as vacuums, the lower secondary nozzles 51 should be used as blowers and vice versa.

Located adjacent to the lower start wheels 57 is an initial cleaning tank 59. As previously stated, the upper conveyor belt 33 has an upper outside section 44 and an upper inside section 45. The lower conveyor belt 36 has a lower outside section 49 and a lower inside section 47. The upper side section 45 of the upper conveyor belt 33 and the lower inside section 47 of the lower conveyor belt 36 operate in a spaced relationship and a product 61 to be cleaned is placed between the upper inside sections 45 of the upper conveyor belt 33 and the lower inside section 47 of the lower conveyor belt 36.

Idler wheels 63 are used to direct both the upper inside section 45 of the upper conveyor belt 33 and the lower inside section 47 of the lower conveyor belt 36 into the initial cleaning tank 59 which is located adjacent the lower start wheels 37 and toward the finish end 17 of the lower conveyor 35. Air nozzles 65 into the initial cleaning tank 59 so that the product 61 on the upper conveyor belt 33 and the lower conveyor belt 36 is agitated by air being blown against the product 61 in the initial cleaner tank 59. As the upper inside section 45 of the upper conveyor belt 33 and the lower conveyor belt 36 into th secondary cleaning tank 67 where again air inlets 65 are directed against the product 61. If the initial cleaning tank 59 did not loosen all of the undesired matter that needed to be removed, the product 61 is then passed through lower secondary nozzles 57 and upper secondary nozzles 53 which again act as blowers and vacuums but in alternate positions from that used by the upper and lower initial nozzles 51,55.

The upper finish wheels 39 and the lower finish wheels 39 both have gears 73 mounted on them that are the same size. A motor 75 is located on the frame 11 adjacent the lower finish wheel 39. A motor rear 77 engages the gear 73 on the lower finish wheels 39. Through a pair of transfer gears 79, the motion of the lower finish wheel 39 is conveyed to the upper finish wheel 29. Both gears 73 are the same size so that the upper conveyor belt 33 and the lower conveyor belt 36 at the same rate of speed.

It is to be understood that the drawings and descriptive matter are in all cases to be interpreted as merely illustrative of the principals of the invention, rather than as limiting the same in any way, since it is contemplated that various elements to achieve the results without departing from the spirit of the invention or the scope of the invention or the scope of the impended claims.

The claims are as follows:

1. An apparatus for cleaning products comprising:
a support frame;
an cupper conveyor having an upper outside section and an upper inside section mounted on the frame;
a lower conveyor having a lower outside section and a lower inside section mounted on the frame, the upper inside section of the upper conveyor and the lower inside section of the lower conveyor moving together in a closely spaced relationship;
a plurality of lower nozzles directed upwardly toward the inside section of the lower conveyor belt;
a plurality of upper nozzles directed toward the upper inside section; and
means for driving the upper conveyor and the lower conveyor at substantially the same rate of speed, the inside section of the lower conveyor moving together in the same direction.

2. An apparatus according to claim 1 wherein the frame includes a start end and a finish end with vertically oriented posts at the finish end.

3. An apparatus according to claim 1 wherein the frame includes a start end and a finish end with vertically oriented posts at the finish end and top supports that are horizontally oriented and supported by the start posts and the finish posts.

4. An apparatus according to claim 1 wherein:
the upper conveyor includes upper start wheels, the upper conveyor being mounted on the upper start wheels and the upper finish wheels; and
the lower conveyor includes lower start wheels an lower finish wheels.

5. An apparatus according to claim 1 further including a wash tank located between the lower outside section and the lower inside section of the lower conveyor.

6. An apparatus according to claim 1 further including:
a wash tank located between the lower outside section and the lower inside section of the lower conveyor, the wash tank including air nozzles to inject air into the wash tank.

7. An apparatus according to claim 1 wherein the conveyor belt includes a plurality of wires at right angles to one another forming generally square openings.

8. An apparatus for cleaning products comprising:
a support frame having a start end and a finish end, a top member and a base;
an upper conveyor including start wheels and a pair of upper finish wheels, an upper conveyor belt being formed from an open sire mesh mounted to move on the upper start wheels and the upper finish wheels, the upper conveyor belt having an upper outside section and an upper inside section;
a lower conveyor including a pair of lower start wheels and a pair of lower finish wheels, a lower conveyer belt formed from open wire mesh mounted to move on the lower start wheels and the lower finish wheels, the lower conveyor belt having a lower outside section and a lower inside section, the inside section of the upper conveyor and the inside section of the lower conveyor adapted to move together in a spaced relationship;
a plurality of lower nozzles directed upwardly toward the inside section of the lower conveyor belt;
a plurality of upper nozzles directed downwardly toward the upper inside section of the upper conveyor;
an upper gear affixed to the upper finish wheel and a lower finish gear affixed to the lower finish gear, the upper finish gear and the lower finish gear being the same size; and
means to rotate the upper gear and the lower gear to move the inside section of the upper conveyor and the inside section of the lower conveyor at the same rate of speed and in the same direction.

9. An apparatus according to claim 8 further including start posts at the start end and finish posts at the finish end and top supports that are horizontally oriented and connected to the start posts and the finish posts.

10. An apparatus according to claim 8 further including start posts at the start end and finish posts at the finish end and top supports that are horizontally oriented and connected to the start posts and the finish posts, the upper start wheels being mounted on the start posts toward the top supports and the upper finish wheels being mounted on the finish posts toward the top support; and
the lower start wheels being mounted on the start posts toward the base and the lower finish wheels being mounted on the start posts toward the base and the lower finish wheels being mounted on the finish posts toward the base.

11. An apparatus according to claim 8 further including a wash tank located between the lower outside section and the lower inside section of the lower conveyor.

12. An apparatus for cleaning products comprising:
a support frame having a start end and a finish end, a top member and a base and including start posts that are vertically oriented at the start end and finish posts at the finish end that are vertically oriented, top supports that are horizontally oriented and connected to the start posts and the finish posts and lower horizontal supports, the lower horizontal supports being connected to the start posts and the finish posts;
an upper conveyor including start wheels and a pair of upper finish wheels, the upper start wheels being mounted on the start posts toward the to support and the upper finish wheels being mounted on the finish posts toward the top support, an upper conveyor belt being formed from an open sire mesh mounted to move on the upper start wheels and the upper finish wheels, the upper conveyor belt having an upper outside section and an upper inside section;
a lower conveyor including a pair of lower start wheels and a pair of lower finish wheels, the lower start wheels being mounted on the start posts toward the base and the finish wheels and being mounted on the finish posts toward the base; a lower conveyer belt formed from open wire mesh mounted to move on the lower start wheels and the lower finish wheels, the lower conveyor belt having a lower outside section and a lower inside section, the inside section of the upper conveyor and the inside section of the lower conveyor adapted to move together in a spaced relationship;
a wash tank mounted between the lower vertical section and the lower inside section including air nozzles to inject air into the wash tank;
a plurality of lower nozzles directed upwardly toward the inside section of the lower conveyor belt;
a plurality of upper nozzles directed downwardly toward the upper inside section of the upper conveyor;
an upper gear affixed to the upper finish wheel and a lower finish gear affixed to the lower finish gear, the upper finish gear and the lower finish gear being the same size; and
means to rotate the upper gear and the lower gear to move the inside section of the upper conveyor and the inside section of the lower conveyor at the same rate of speed and in the same direction.

13. An apparatus according to claim 12 further including an additional wash tank mounted between the lower outside section and the lower inside section.

14. An apparatus according to claim 12 further including:
a plurality of secondary nozzles, directed upwardly toward the inside section of the lower conveyor belt; and
A plurality of secondary upper nozzles directed downwardly toward the upper inside section of the upper conveyor.
